(19) United States
(12) Patent Application Publication
(10) Pub. No.: US 2002/0088158 A1
(43) Pub. Date: Jul. 11, 2002

(54) Note storage and display device

(76) Inventor: Stephen J. Jones, Orem, UT (US)

Correspondence Address: Michael F. Krieger, KIRTON & McCONKIE, 60 East South Temple, Suite 1800, Salt Lake City, UT, 84111, US

(21) Appl. No.: 10/041,286

(22) Filed: Jan. 4, 2002

Related U.S. Application Data
(60) Provisional application No. 60/260,070, filed on Jan. 5, 2001.

(51) Int. Cl. G09F 7/02

(52) U.S. Cl. 40/658; 40/611

(57) ABSTRACT

Systems and methods for selectively storing and/or displaying one or more of a variety of notes on a given surface. A note holding device is configured to selectively and removably store and/or display a note and comprises a backing portion, a biasing portion, and a removal resistance portion. The backing portion includes a planar surface for attaching the note holding device to a given surface. The biasing portion is coupled to the backing portion and provides a biasing toward the backing portion so as to hold a note between the biasing portion and the backing portion. The resistance removal portion is attached to the biasing portion and is biased against the backing portion by the biasing portion. The resistance removal portion provides resistance to a note that is inserted into the holding device to prevent an inadvertent release of the note from the holding device and to allow a user to remove the note from the device by overcoming the resistance. The removal is allowed to occur without any manipulation of the note holding device.

### RELATED APPLICATIONS

This application claims priority to U.S. Provisional Patent Application Serial No. 60/260,070 filed Jan. 5, 2001, entitled “NOTE STORAGE AND DISPLAY DEVICE.”

### BACKGROUND OF THE INVENTION

1. Field of the Invention

The present invention relates to systems and methods for storing and displaying notes. More particularly, the present invention relates to selectively storing and/or displaying one or more of a variety of notes on a given surface.

2. Background and Related Art

Individuals have traditionally used paper for writing down or recording information. Commonly, the paper becomes co-mingled other papers and becomes lost or forgotten. To place a paper having important information thereon in a visible location, individuals typically employ a tack, adhesive tape, a magnet or another devices to attach the paper in the visible location. Such devices, introduce a variety of problems, including damaging the paper and allowing the paper to be inadvertently detached from the location.

More recently, self-adhesive note pads were developed that include individual sheets, where each sheet allows an individual to write on a front side and includes an adhesive on the back side to enable attachment of the sheet to a surface. The note pads are available in a variety of forms, shapes and sizes, can be easily transferred from location to location, and are commonly used. For example, individual sheets from a self-adhesive note pad may be used to memorialize phone messages, personal reminders, or may be used for any number of reasons. The advantages of using the self-adhesive note pads include convenience and flexibility.

Some problems exist with using the self-adhesive note pads. One problem is that each sheet can only be transferred so many times before it loses its adhesive qualities. Another problem is that when such sheets are used frequently, they become inconvenient and troublesome to transfer a number of the sheets at once. For instance, two or three sheets can easily be transferred from a counter top or computer screen to a day planner or to another location. However, as the number of sheets increases, the sheets become less convenient to transfer.

Another problem with using a self-adhesive sheet is that it is often placed in locations that make it difficult to write on the sheet. For example, such sheets are often placed on the sides of computer monitors or on the edges of shelves or desks. While these locations are often very convenient for viewing, each sheet must be removed individually and placed on a different surface in order to add or change information. Removing a sheet decreases its life and makes such sheets less convenient.

Thus, a variety of problems exist with the traditional techniques available to locate a paper in a visible or desired location. Accordingly, it would be an improvement in the art to augment or event replace the traditional techniques with other methods.

### SUMMARY OF THE INVENTION

The present invention relates to systems and methods for storing and displaying notes. More particularly, the present invention relates to selectively storing and/or displaying one or more of a variety of notes on a given surface.

Implementation of the present invention takes place in association with a note holding device that is configured to selectively and removably store and/or display a note. In one implementation, the note holding device comprises a backing portion, a biasing portion, and a removal resistance portion. The backing portion includes a planar surface for attaching the note holding device to a given surface. The biasing portion is coupled to the backing portion and provides a biasing toward the backing portion so as to hold a note between the biasing portion and the backing portion. The resistance removal portion is attached to the biasing portion and is biased against the backing portion by the biasing portion. The resistance removal portion provides resistance to a note that is inserted into the holding device to prevent an inadvertent release of the note from the holding device and to allow a user to remove the note from the device by overcoming the resistance. The removal is allowed to occur without any manipulation of the note holding device.

While the methods and processes of the present invention have proven to be particularly useful in the area of holding notes, those skilled in the art can appreciate that the methods and processes can be used in association with a variety of items for storage and/or display, where the items include a thickness similar to the thickness of a note.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIGS. 1-2 illustrate a representative method for assembling an embodiment of the present invention;

FIG. 3 illustrates another embodiment of a note holding device in accordance with the present invention; and

FIG. 4 illustrates the embodiment of FIG. 3 attached to a surface.

### DETAILED DESCRIPTION OF THE INVENTION

The present invention relates to systems and methods for storing and displaying notes. More particularly, the present invention relates to selectively storing and/or displaying one or more of a variety of notes on a given surface.

In the disclosure and in the claims the term “note” shall refer to any item having a planar portion of the thickness similar to the thickness of a sheet of paper. Such examples of a note includes a sheet of paper, a card, cardstock, a photograph, a picture, a plastic sheet, an envelope, and the like.

Embodiments of the present invention takes place in association with a note holding device that is configured to selectively and removably store and/or display a note. In one embodiment, the note holding device comprises a backing portion, a biasing portion, and a removal resistance portion. The backing portion includes a planar surface for attaching the note holding device to a given surface. The biasing portion is coupled to the backing portion and provides a biasing toward the backing portion so as to hold a note between the biasing portion and the backing portion. The resistance removal portion is attached to the biasing portion and is biased against the backing portion by the biasing portion. The resistance removal portion provides resistance to a note that is inserted into the note holding device to prevent an inadvertent release of the note from the holding device and to allow a user to remove the note from the device by overcoming the resistance. The removal is allowed to occur without any manipulation of the note holding device.

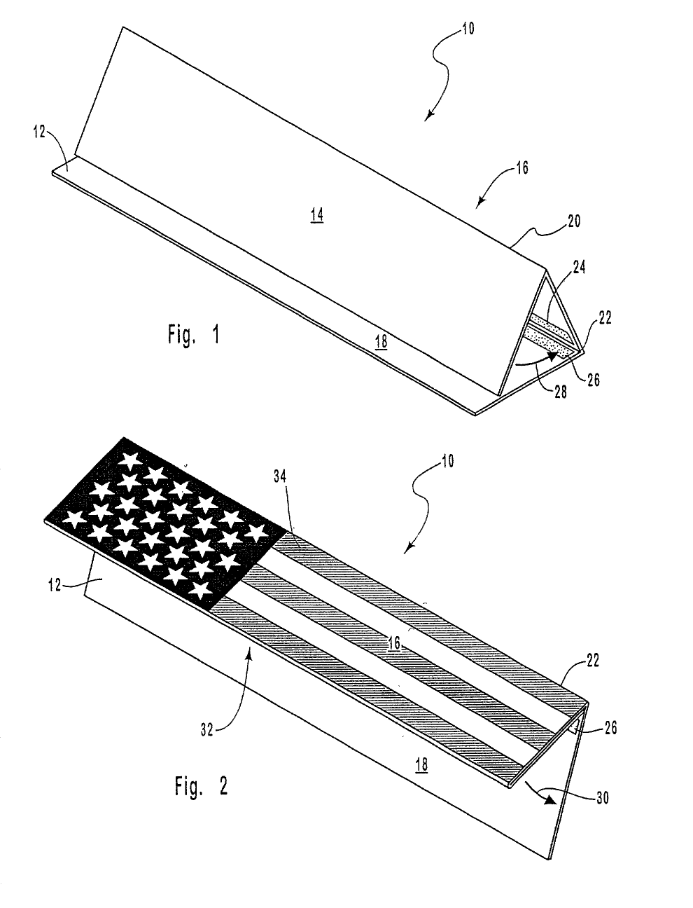

With reference now to FIGS. 1 and 2, a representative method is illustrated for assembling a note holding device in accordance with the present invention. In FIG. 1, note holding device 10 is created by selectively forming a single sheet of material 12. The material may comprise paper, plastic, metal, vinyl, wood, or another material that will provide the biasing used to hold a note as disclosed herein. Furthermore, embodiments of the present invention embrace the utilization of a material that is transparent, semi-transparent, opaque, or semi-opaque. In one embodiment where the material comprises paper, the thickness of the material is 8 mil to 16 mil. However, other embodiments exist that comprise a greater or lesser thickness of paper. Moreover, in one embodiment where the material comprises vinyl, the thickness of the vinyl is 5 mil to 15 mil. However, other embodiments exist that comprise a greater or lesser thickness of paper.

Note holder device 10 comprises portions 14, 16, and 18. Portion 14 is formed and defined by folding material 12 at fold 20. Portion 18 is formed and defined by folding material 12 at fold 22. Thus, portion 16 is formed and defined by both fold 20 and fold 22. Moreover, portion 14 is coupled to portion 16 at fold 20 and portion 16 is coupled to portion 18 at fold 22. While in the illustrated embodiment portions 14, 16, and 18 were formed by folding a single sheet of material 12, those skilled in the art will appreciate that embodiments of the present invention embrace more than one sheet coupled together to form a note holder device. For example, in one embodiment two or more separate sheets of material may be coupled by the use of an adhesive or another coupling device to form a note holding device that provides biasing to hold and/or display a note in accordance with the present invention.

With reference back to the embodiment illustrated in FIG. 1, arrow 28 indicates that portion 14 is folded towards portion 16 and an adhesive 24 is employed to couple an inside surface of portion 14 to an inside surface of portion 16. With reference now to FIG. 2, arrow 30 indicates that portion 16 is folded toward portion 18 and an adhesive 26 is employed to couple an inside surface of portion 18 with portion 14, which is attached underneath portion 16 in FIG. 2.

Those skilled in the art will appreciate that a variety of adhesives may be used, including a variety of adhesive tapes (e.g., double-faced adhesive tape), and a variety of adhesive glues. Furthermore, those skilled in the art will appreciate that the portions of a note holding device of the present invention may be coupled using other methods, including melting, soldering, welding, or any other coupling method that will provide the biasing discussed herein.

In one embodiment where and adhesive glue is used to create a note holding device, rollers are employed to cause an appropriate fold, to distribute the glue and/or to facilitate coupling. Furthermore, in the illustrated embodiment portions 14 and 16 comprise similar heights, however other embodiments allow for differing heights of portions 14 and 16.

In the illustrated embodiment of FIG. 2, when the combination of portions 16 and 14 (located underneath and coupled to portion 16) are coupled to portion 18, a biasing portion of the note holding device 10 is formed. The combination of portions 16 and 14 are an example of a biasing portion. Moreover, portion 18 is an example of a backing portion of note holding device 10 that comprises a planar surface for attaching note holding device to a surface, as will be further discussed below. The biasing portion is coupled to the backing portion by adhesive 26. The biasing portion biases toward the backing portion so as to hold a note (not shown) in a location 32 that is between the biasing portion and the backing portion, as will be further discussed below. Backing portion may be attached to a surface using a variety of coupling techniques, including using adhesive tape, a magnet, tacks, glue, nails, screws, or any other such coupling technique.

In FIG. 2, note holding device 10 includes a design 34 thereon. Design 34 may include text and/or graphics. Furthermore, design 34 may include contact information, business information, a picture of a loved one, a company name or logo, a calendar, a trademark, or any other decoration, design, pattern, color, or the like. Furthermore, note holder device may comprise a variety of different shapes and/or sizes that allow for the holding of a note in accordance with the present invention. Moreover, a note holder device of the present invention may be given to customers by businesses as a promotional or gift item to remind the customers of the business.

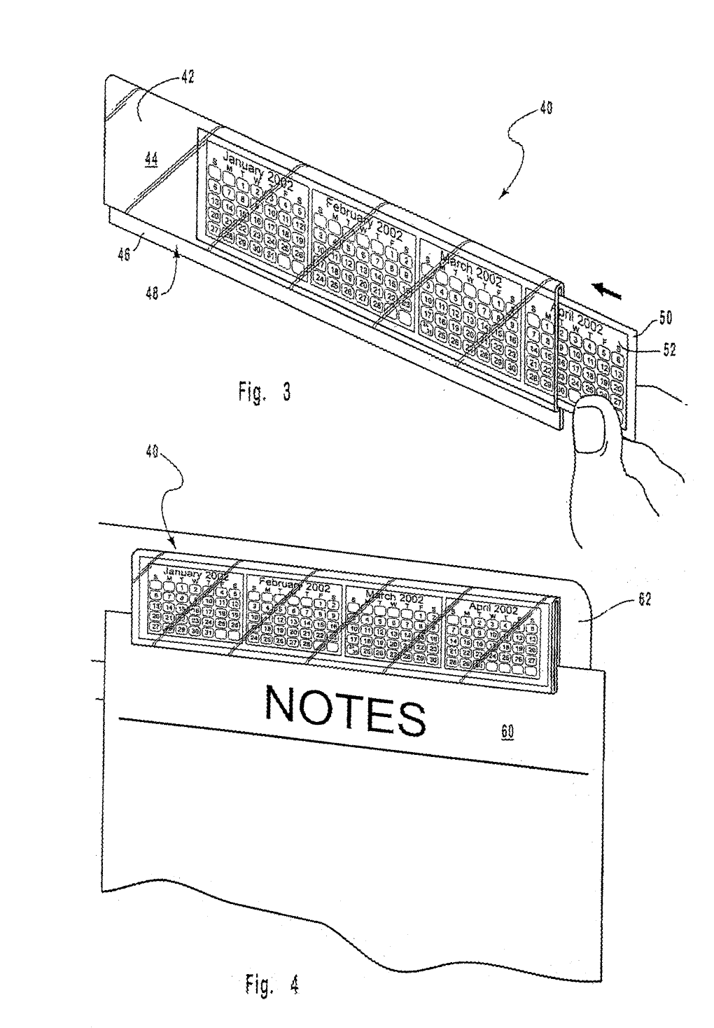

With reference now to FIG. 3, another embodiment of a note holding device is illustrated as note holding device 40, which comprises a transparent or semi-transparent material 42, a biasing portion 44 and a backing portion 46. The biasing portion 44 is coupled to the backing portion 46 so as to selectively hold or maintain a note at a location 48 between the biasing portion 44 and the backing portion 46. Location 48 is configured to receive at least a portion of the note, as illustrated in combination with FIG. 4 by note holding device 40 holding a portion of note 60.

The biasing caused in accordance with the present invention holds the note between the biasing portion 44 and the backing portion 46. Furthermore, the design of note holding device 40 provides for a removal resistance portion at location 48 due to friction and to the biasing. The removal resistance portion is attached to the biasing portion 44 and is biased against the backing portion 48 by the biasing portion 44. The resistance removal portion provides resistance, such as by through friction, to at least a portion of note 60, which is inserted into the note holding device 40. The resistance prevents an inadvertent release of note 60 from the note holding device 40. Furthermore, the resistance allows a user to remove note 60 from the note holding device 40 by pulling note 60 from location 48 with a force that overcomes the force of the resistance. Moreover, the removal of note 60 from note holding device 40 may take place single handedly and without any manipulation of the note holding device 40.

In FIG. 3, a slot is created between biasing portion 44 and backing portion 46 that enables an insert 50 to be slid therein. The insert may include a design 52 thereon. As discussed above, the design may include text, graphics, pictures, etc., and may comprise a variety of different colors and/or shapes. In FIG. 3, design 52 comprises a calendar that may be selectively replaced as necessary. In other embodiments, the design includes a listing of frequently called telephone numbers, or other similar information that is commonly used. In another embodiment, the design includes important dates for an individual, such as an anniversary date, various birth dates, and other such important dates as a reminder to the individual.

While note holding device 40 is illustrated in FIG. 4 as being coupled to surface 62 in a horizontal orientation, those skilled in the art will appreciate that a note holding device may be coupled a vertical orientation, a transverse orientation, or any other orientation. Moreover, the note holding device may hold to a top portion of a note, a bottom portion of a note, a corner of a note, or a side portion of a note. Those skilled in the art will also appreciate that a note holding device may hole a variety of different notes at the same time.

Note holding device 40 may be coupled to surface 62 through the use of a variety of techniques. For example, adhesive tape, stick tack, glue, nails, screws, hooks, pins, or any other coupling device may be used to couple device 40 to surface 62. Furthermore device 40 may be permanently or removably attached to surface 62.

The surface, illustrated as surface 62, to which a note holding device may be attached include a surface of a computer monitor, a wall, a window, a door, a shelf, an appliance, a telephone, a white board, a chalk board, a vehicle, or any other suface.

Embodiments of the present invention also embrace a backing portion that extends farther than provided in the illustrated embodiments to provide a stiff surface behind the note being held and while a user writes on the note.

Thus, as discussed herein, the embodiments of the present invention embrace systems and methods for selectively storing and/or displaying one or more of a variety of notes on a given surface. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A note holding device comprising:
a backing portion having a planar surface for attaching the note holding device to a surface;
a biasing portion coupled to the backing portion, the biasing portion biasing toward the backing portion so as to hold a note between the biasing portion and the backing portion; and
a removal resistance portion attached to the biasing portion and biased against the backing portion by the biasing portion, said removal resistance portion providing resistance to a note inserted into the device to prevent inadvertent release of the inserted note from the device and allowing a user to remove the inserted note from the device by overcoming the resistance, said removal occurring without any manipulation of the note holding device.

2. A note holding device as recited in claim 1, wherein a coupling device attaches the note holding device to a surface.

3. A note holding device as recited in claim 2, wherein the coupling device comprises at least one of:
(i) an adhesive glue;
(ii) an adhesive tape;
(iii) a magnet;
(iv) a nail;
(v) a screw;
(vi) a bolt; and
(vii) a pin.

4. A note holding device as recited in claim 1, wherein the note holding device comprises paper.

5. A note holding device as recited in claim 1, wherein the note holding device comprises at least one of:
(i) plastic; and
(ii) vinyl.

6. A note holding device as recited in claim 5, wherein the vinyl is at least semitransparent.

7. A note holding device as recited in claim 6, further comprising a slot located between the biasing portion and the backing portion.

8. A note holding device as recited in claim 7, further comprising an insert, wherein the insert is slidably located in the slot.

9. A note holding device as recited in claim 8, wherein the insert includes a design.

10. A note holding device as recited in claim 1, further comprising a design on a surface of the biasing portion.

11. A note holding device as recited in claim 1, wherein the surface is a portion of a computer monitor.

12. A note holding device comprising:
a backing portion having a planar surface;
a surface coupling device attached to a portion of the backing portion for attaching the note holding device to a surface;
a biasing portion coupled to the backing portion, the biasing portion biasing toward the backing portion so as to hold a note in a generally parallel orientation with respect to backing portion, wherein the note is held between the biasing portion and the backing portion; and
a removal resistance portion attached to the biasing portion and biased against the backing portion by the biasing portion, said removal resistance portion providing resistance to a note inserted into the device to prevent inadvertent release of the inserted note from the device and allowing a user to remove the inserted note from the device by overcoming the resistance, said removal occurring without any manipulation of the note holding device.

13. A note holding device as recited in claim 12, wherein the surface coupling device removably attaches the note holding device to the surface.

14. A note holding device as recited in claim 13, wherein the surface coupling device comprises at least one of:
(i) a magnet; and
(ii) an adhesive.

15. A note holding device as recited in claim 12, wherein the note holding device comprises a paper product.

16. A note holding device as recited in claim 12, wherein the note holding device comprises a plastic material.

17. A note holding device as recited in claim 12, wherein the note holding device comprises a vinyl material.

18. A note holding device as recited in claim 12, wherein the note holding device comprises a material that is at least semi-transparent.

19. A note holding device as recited in claim 12, wherein the biasing portion includes a design thereon.

20. A method for forming a note holder device, the method comprising the steps for:
providing a material;
coupling a portion of an inside surface of a first portion of the material with an inside surface of a middle portion of the material to form a biasing portion of the note holding device;
coupling a portion of the biasing portion of the note holding device with an inside surface of a backing portion of the holding device, wherein the biasing portion is biased toward the backing portion so as to hold a note between the biasing portion and the backing portion, and wherein the combination of the biasing portion and the backing portion provides a resistance to the note to prevent an inadvertent release of the note from the holding device and allowing a user to remove the note from the device by overcoming the resistance, and wherein the removal occurs without any manipulation of the note holding device.
